(19) United States
(12) Patent Application Publication
(10) Pub. No.: US 2025/0350723 A1
(43) Pub. Date: Nov. 13, 2025

(54) Method and Apparatus for Entropy Coding Partition Splitting Decisions in Video Coding System

(71) Applicant: MEDIATEK INC., Hsinchu City (TW)

(72) Inventors: Chun-Chia CHEN, Hsinchu City (TW); Shih-Ta HSIANG, Hsinchu City (TW); Tzu-Der CHUANG, Hsinchu City (TW); Chih-Wei HSU, Hsinchu City (TW); Ching-Yeh CHEN, Hsinchu City (TW); Yu-Wen HUANG, Hsinchu City (TW)

(21) Appl. No.: 18/871,222

(22) PCT Filed: May 10, 2023
(86) PCT No.: PCT/CN2023/093136

§ 371 Date: Dec. 3, 2024

Related U.S. Application Data
(60) Provisional application No. 63/349,181, filed on Jun. 6, 2022.

(51) Int. Cl. H04N 19/119; H04N 19/13; H04N 19/172; H04N 19/91; H04N 19/96

(52) U.S. Cl. CPC H04N 19/119; H04N 19/13; H04N 19/172; H04N 19/91; H04N 19/96

(57) ABSTRACT

Methods of entropy coding of block partitioning with initial context model probability values indicated by high-level syntaxes or with different context models for HBT (Horizontal Binary Tree) and VBT (Vertical Binary Tree). For one method, one or more coded bits, including encoded data for information related to a partitioning tree of the current picture area, are signalled or parsed from a bitstream. Entropy coding is applied to the coded bits using context formation, including one or more initial context model probability values derived according to a video content type of the current picture, to recover the partitioning tree information. For another method, entropy coding is applied to the coded bits by using one or more context models to recover the first information related to the partitioning tree and the context models are different for HBT and VBT applied to a non-square block.

### CROSS REFERENCE TO RELATED APPLICATIONS

The present invention is a non-Provisional Application of and claims priority to U.S. Provisional Patent Application No. 63/349,181, filed on Jun. 6, 2022. The U.S. Provisional Patent Application is hereby incorporated by reference in its entirety.

### FIELD OF THE INVENTION

The present invention relates to video coding system. In particular, the present invention relates to partitioning blocks using one or context models in a video coding system.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In the current invention, methods and apparatus to improve entropy coding of the partitioning information are disclosed.

### BRIEF SUMMARY OF THE INVENTION

Method for entropy coding of partitioning information are disclosed. According to one method, input data associated with a current picture area in a current picture are received, wherein the input data comprise pixel data associated with the current picture area to be encoded. The current picture area is partitioned into one or more blocks according to a partitioning tree. Entropy encoding is applied to first information related to the partitioning tree to generate one or more coded bits by using context formation, wherein the context formation comprises one or more initial context model probability values derived according to a video content type of the current picture. Said one or more coded bits are signalled in a bitstream.

The corresponding decoding method is also disclosed. Input data associated with a current picture area in a current picture are received, wherein the input data comprise encoded data associated with the current picture area to be decoded. One or more high-level syntaxes are parsed from the bitstream. Entropy decoding is applied to said one or more coded bits by using context formation to recover the first information related to the partitioning tree, wherein the context formation comprises one or more initial context model probability values as indicated by said one or more high-level syntaxes. The current picture area is then partitioned into one or more blocks according to the partitioning tree for decoding said one or more blocks.

In one embodiment, the first information comprises one or more CU (Coding Unit) split flags. In another embodiment, the first information comprises CU split decision other than said one or more CU split flags.

In one embodiment, said one or more initial context model probability values are derived according to a video content type. In one embodiment, the video content type belongs to a group comprising screen video content, activity level of input video, or a combination thereof. Furthermore, said one or more high-level syntaxes can be signalled or parsed from SPS (sequence parameter set), PPS (picture parameter set), PH (picture head), SH (slice header), or a combination thereof.

In one embodiment, whether to allow said one or more initial context model probability values is controlled by one or more high-level syntaxes signalled or parsed from the bitstream. For example, said one or more high-level syntaxes can be signalled or parsed from the bitstream at a picture level, slice level, tile level, CTU-row level, CTU level, VPDU level, or a combination thereof.

According to another method, at the encoder side, entropy encoding is applied to first information related to the partitioning tree to generate one or more coded bits by using one or more context models, wherein said one or more context models are different for HBT (Horizontal Binary Tree) and VBT (Vertical Binary Tree) applied to a non-square block. At the decoder side, entropy decoding is applied to said one or more coded bits by using one or more context models to recover the first information related to the partitioning tree, wherein said one or more context models are different for HBT (Horizontal Binary Tree) and VBT (Vertical Binary Tree) applied to a non-square block.

In one embodiment, for the non-square block with block height larger than block width, the non-square block has a higher probability to be partitioned using the HBT than the VBT. In another embodiment, for the non-square block with block width larger than block height, the non-square block has a higher probability to be partitioned using the VBT than the HBT.

In one embodiment, said one or more context models are further dependent on block shape of the non-square block. In another embodiment, said one or more context models are further dependent on split information, block size, block shape, or a combination thereof related to a parent node of the non-square block.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows an example of a picture divided into CTUs

FIG. 3 shows an example of raster-scan slice partitioning of a picture, where the picture is divided into 12 tiles and 3 raster-scan slices.

FIG. 4 shows an example of a picture partitioned into tiles and rectangular slices FIG. 5 shows an example of a picture partitioned into 4 tiles and 4 rectangular slices FIG. 6 shows an example of a picture partitioned into 28 subpictures

FIG. 7 illustrates examples of a multi-type tree structure corresponding to vertical binary splitting (SPLIT_BT_VER), horizontal binary splitting (SPLIT_BT_HOR), vertical ternary splitting (SPLIT_TT_VER), and horizontal ternary splitting (SPLIT_TT_HOR).

FIG. 8 illustrates an example of the signalling mechanism of the partition splitting information in quadtree with nested multi-type tree coding tree structure.

FIG. 9 shows an example of a CTU divided into multiple CUs with a quadtree and nested multi-type tree coding block structure, where the bold block edges represent quadtree partitioning and the remaining edges represent multi-type tree partitioning.

FIG. 10 shows an example of TT split forbidden when either width or height of a luma coding block is larger than 64.

FIG. 11 illustrates an exemplary block diagram of the CABAC process.

FIG. 12 shows an example of partitioning information in a picture.

FIG. 13 illustrates a flowchart of an exemplary video decoding system that utilizes one or more initial context model probability values derived according to a video content type of the current picture for entropy decoding of the partition information according to an embodiment of the present invention.

FIG. 14 illustrates a flowchart of an exemplary video decoding system that utilizes one or more initial context model probability values derived according to a video content type of the current picture for entropy decoding of the partition information according to an embodiment of the present invention.

FIG. 15 illustrates a flowchart of an exemplary video decoding system that utilizes different context models for HBT and VBT for entropy decoding of the partition information according to an embodiment of the present invention.

FIG. 16 illustrates a flowchart of an exemplary video encoding system that utilizes different context models for HBT and VBT for entropy encoding of the partition information according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The VVC standard incorporates various new coding tools to further improve the coding efficiency over the HEVC standard. Among various new coding tools, some coding tools relevant to the present invention are reviewed as follows.

Partitioning of the Picture into CTUs

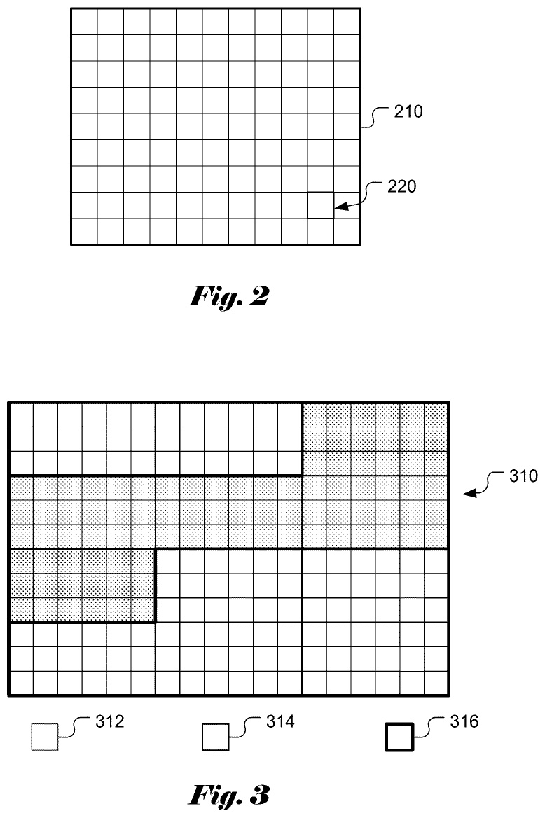

Pictures are divided into a sequence of coding tree units (CTUs). The CTU concept is same to that of the HEVC. For a picture that has three sample arrays, a CTU consists of an N×N block of luma samples together with two corresponding blocks of chroma samples. FIG. 2 shows an example of a picture divided into CTUs, where the thick-lined box 210 corresponds to a picture and each small rectangle (e.g. box 220) corresponds to one CTU.

The maximum allowed size of the luma block in a CTU is specified to be 128×128 (although the maximum size of the luma transform blocks is 64×64).

Partitioning of Pictures into Subpictures, Slices, Tiles

A picture is divided into one or more tile rows and one or more tile columns. A tile is a sequence of CTUs that covers a rectangular region of a picture.

A slice consists of an integer number of complete tiles or an integer number of consecutive complete CTU rows within a tile of a picture.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice. A subpicture contains one or more slices that collectively cover a rectangular region of a picture.

FIG. 3 shows an example of raster-scan slice partitioning of a picture 310, where the picture is divided into 12 tiles 314 (and 3 raster-scan slices 316. Each small rectangle 312 corresponds to one CTU.

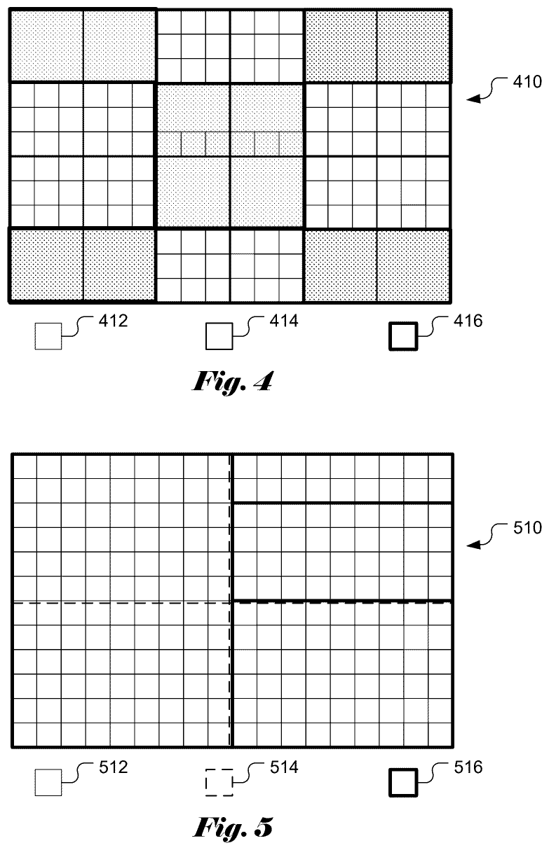

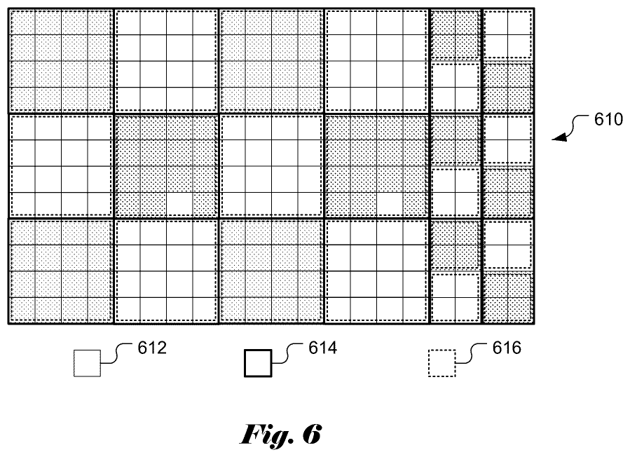

FIG. 4 shows an example of rectangular slice partitioning of a picture 410, where the picture is divided into 24 tiles 414 (6 tile columns and 4 tile rows) and 9 rectangular slices 416. Each small rectangle 412 corresponds to one CTU.

FIG. 5 shows an example of a picture 510 partitioned into tiles and rectangular slices, where the picture 510 is divided into 4 tiles 514 (2 tile columns and 2 tile rows) and 4 rectangular slices 516. Each small rectangle 512 corresponds to one CTU.

FIG. 6 shows an example of subpicture partitioning of a picture 610, where the picture 610 is partitioned into 18 tiles 614, 12 on the left-hand side each covering one slice of 4 by 4 CTUs and 6 tiles on the right-hand side each covering 2 vertically-stacked slices of 2 by 2 CTUs, altogether resulting in 24 slices 616 and 24 subpictures 616 of varying dimensions (each slice is also a subpicture). Each small rectangle 612 corresponds to one CTU.

### Partitioning of the CTUs Using a Tree Structure

In HEVC, a CTU is split into CUs by using a quaternary-tree (QT) structure denoted as coding tree to adapt to various local characteristics. The decision regarding whether to code a picture area using inter-picture (temporal) or intra-picture (spatial) prediction is made at the leaf CU level. Each leaf CU can be further split into one, two or four PUs (Prediction Units) according to the PU splitting type. Inside one PU, the same prediction process is applied and the relevant information is transmitted to the decoder on a PU basis. After obtaining the residual block by applying the prediction process based on the PU splitting type, a leaf CU can be partitioned into transform units (TUs) according to another quaternary-tree structure similar to the coding tree for the CU. One of key feature of the HEVC structure is that it has the multiple partition conceptions including CU, PU, and TU.

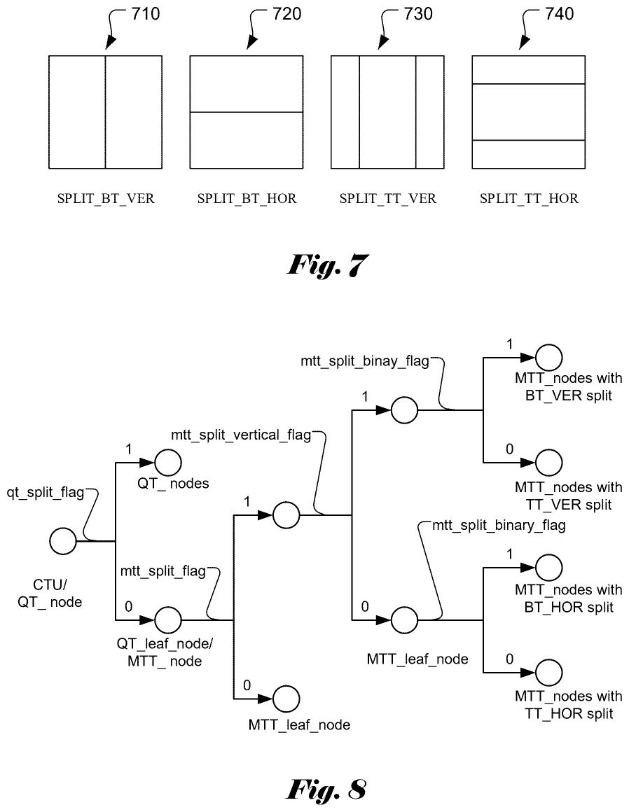

In VVC, a quadtree with nested multi-type tree using binary and ternary splits segmentation structure replaces the concepts of multiple partition unit types, i.e. it removes the separation of the CU, PU and TU concepts except as needed for CUs that have a size too large for the maximum transform length, and supports more flexibility for CU partition shapes. In the coding tree structure, a CU can have either a square or rectangular shape. A coding tree unit (CTU) is first partitioned by a quaternary tree (a.k.a. quadtree) structure. Then the quaternary tree leaf nodes can be further partitioned by a multi-type tree structure. As shown in FIG. 7, there are four splitting types in multi-type tree structure, vertical binary splitting (SPLIT_BT_VER 710), horizontal binary splitting (SPLIT_BT_HOR 720), vertical ternary splitting (SPLIT_TT_VER 730), and horizontal ternary splitting (SPLIT_TT_HOR 740). The multi-type tree leaf nodes are called coding units (CUs), and unless the CU is too large for the maximum transform length, this segmentation is used for prediction and transform processing without any further partitioning. This means that, in most cases, the CU, PU and TU have the same block size in the quadtree with nested multi-type tree coding block structure. The exception occurs when maximum supported transform length is smaller than the width or height of the colour component of the CU.

FIG. 8 illustrates the signalling mechanism of the partition splitting information in quadtree with nested multi-type tree coding tree structure. A coding tree unit (CTU) is treated as the root of a quaternary tree and is first partitioned by a quaternary tree structure. Each quaternary tree leaf node (when sufficiently large to allow it) is then further partitioned by a multi-type tree structure. In the multi-type tree structure, a first flag (mtt_split_cu_flag) is signalled to indicate whether the node is further partitioned; when a node is further partitioned, a second flag (mtt_split_cu_vertical_flag) is signalled to indicate the splitting direction, and then a third flag (mtt_split_cu_binary_flag) is signalled to indicate whether the split is a binary split or a ternary split. Based on the values of mtt_split_cu_vertical_flag and mtt_split_cu_binary_flag, the multi-type tree slitting mode (MttSplitMode) of a CU is derived as shown in Table 1.

TABLE 1
MttSplitMode derviation based on multi-type tree syntax elements

| MttSplitMode | mtt_split_cu_vertical_flag | mtt_split_cu_binary_flag |
|---|---|---|
| SPLIT_TT_HOR | 0 | 0 |
| SPLIT_BT_HOR | 0 | 1 |
| SPLIT_TT_VER | 1 | 0 |
| SPLIT_BT_VER | 1 | 1 |

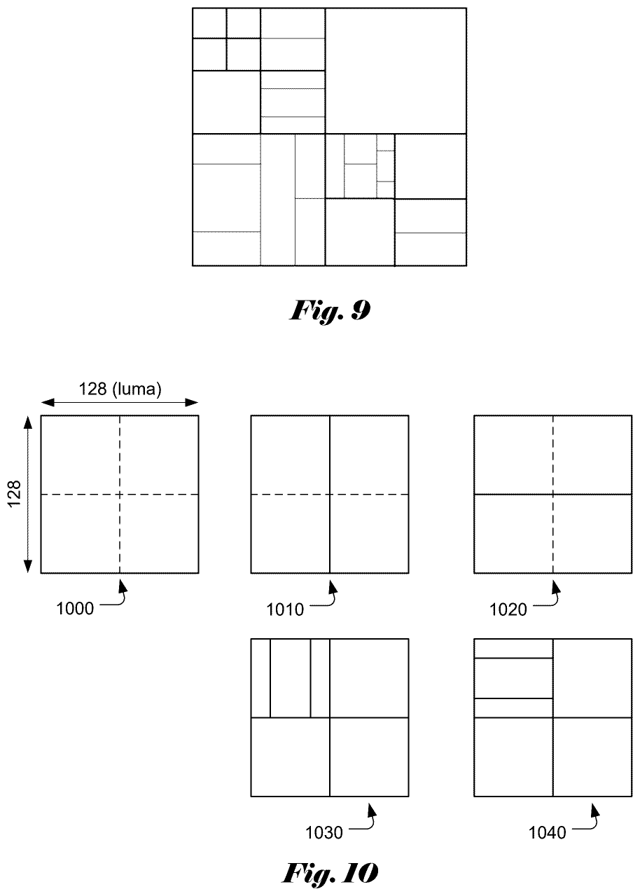

FIG. 9 shows a CTU divided into multiple CUs with a quadtree and nested multi-type tree coding block structure, where the bold block edges represent quadtree partitioning and the remaining edges represent multi-type tree partitioning. The quadtree with nested multi-type tree partition provides a content-adaptive coding tree structure comprised of CUs. The size of the CU may be as large as the CTU or as small as 4×4 in units of luma samples. For the case of the 4:2:0 chroma format, the maximum chroma CB size is 64×64 and the minimum size chroma CB consist of 16 chroma samples.

In VVC, the maximum supported luma transform size is 64×64 and the maximum supported chroma transform size is 32×32. When the width or height of the CB is larger the maximum transform width or height, the CB is automatically split in the horizontal and/or vertical direction to meet the transform size restriction in that direction.

The following parameters are defined and specified by SPS syntax elements for the quadtree with nested multi-type tree coding tree scheme.
CTU size: the root node size of a quaternary tree
MinQTSize: the minimum allowed quaternary tree leaf node size
MaxBtSize: the maximum allowed binary tree root node size
MaxTtSize: the maximum allowed ternary tree root node size
MaxMttDepth: the maximum allowed hierarchy depth of multi-type tree splitting from a quadtree leaf
MinBtSize: the minimum allowed binary tree leaf node size
MinTtSize: the minimum allowed ternary tree leaf node size

In one example of the quadtree with nested multi-type tree coding tree structure, the CTU size is set as 128×128 luma samples with two corresponding 64×64 blocks of 4:2:0 chroma samples, the MinQTSize is set as 16×16, the MaxBtSize is set as 128×128 and MaxTtSize is set as 64×64, the MinBtSize and MinTtSize (for both width and height) is set as 4×4, and the MaxMttDepth is set as 4. The quaternary tree partitioning is applied to the CTU first to generate quaternary tree leaf nodes. The quaternary tree leaf nodes may have a size from 16×16 (i.e., the MinQTSize) to 128×128 (i.e., the CTU size). If the leaf QT node is 128×128, it will not be further split by the binary tree since the size exceeds the MaxBtSize and MaxTtSize (i.e., 64×64). Otherwise, the leaf qdtree node could be further partitioned by the multi-type tree. Therefore, the quaternary tree leaf node is also the root node for the multi-type tree and it has multi-type tree depth (mttDepth) as 0. When the multi-type tree depth reaches MaxMttDepth (i.e., 4), no further splitting is considered. When the multi-type tree node has width equal to MinBtSize and smaller or equal to 2*MinTtSize, no further horizontal splitting is considered. Similarly, when the multi-type tree node has height equal to MinBtSize and smaller or equal to 2*MinTtSize, no further vertical splitting is considered.

To allow 64×64 Luma block and 32×32 Chroma pipelining design in VVC hardware decoders, TT split is forbidden when either width or height of a luma coding block is larger than 64, as shown in FIG. 10, where block 1000 corresponds to a 128×128 luma CU. The CU can be split using vertical binary partition (1010) or horizontal binary partition (1020). After the block is split into 4 CUs, each size is 64×64, the CU can be further partitioned using partitions including TT. For example, the upper-left 64×64 CU is partitioned using vertical ternary splitting (1030) or horizontal ternary splitting (1040). TT split is also forbidden when either width or height of a chroma coding block is larger than 32.

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three colour components unless the video is monochrome.

In the following, techniques to improve the coding performance related to coding trees are disclosed.

For achieving high compression efficiency, the context-based adaptive binary arithmetic coding (CABAC) mode, or known as regular mode, is employed for entropy coding the values of the syntax elements in VVC. FIG. 11 illustrates a block diagram of the CABAC process. Since the arithmetic coder in the CABAC engine can only encode the binary symbol values, the CABAC process needs to convert the values of the syntax elements into a binary string using a binarizer (1110). The conversion process is commonly referred to as binarization. During the coding process, the probability models are gradually built up from the coded symbols for the different contexts. The context modeller (1120) serves the modelling purpose. During normal context based coding, the regular coding engine (1130) is used, which corresponds to a binary arithmetic coder. The selection of the modelling context for coding the next binary symbol can be determined by the coded information. Symbols can also be encoded without the context modelling stage and assume an equal probability distribution, commonly referred to as the bypass mode, for reduced complexity. For the bypassed symbols, a bypass coding engine (1140) may be used. As shown in FIG. 11, switches (S1, S2 and S3) are used to direct the data flow between the regular CABAC mode and the bypass mode. When the regular CABAC mode is selected, the switches are flipped to the upper contacts. When the bypass mode is selected, the switches are flipped to the lower contacts as shown in FIG. 11.

### Proposed Method A: Context Modelling Considering Reference Pictures

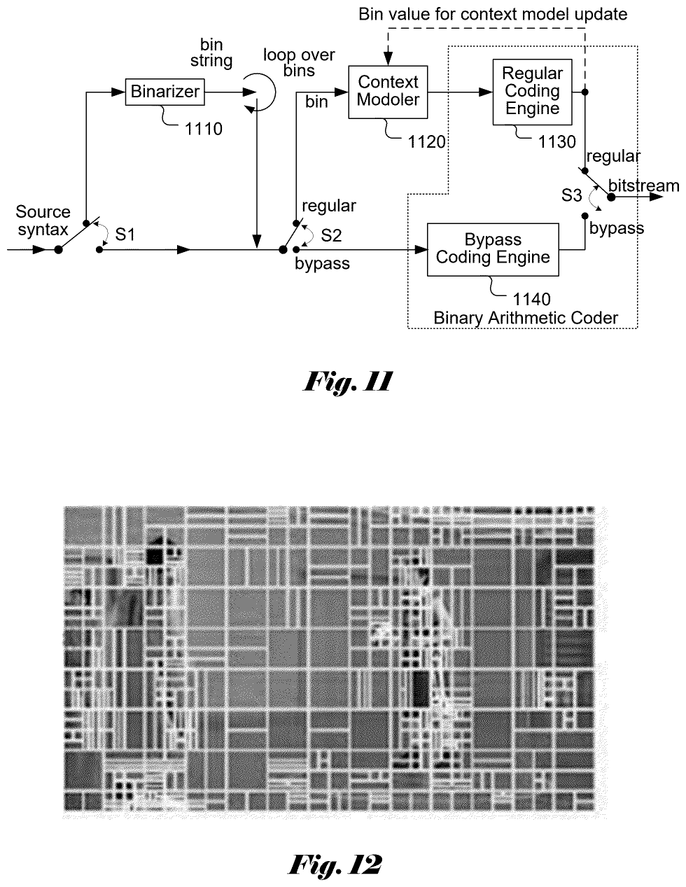

In this proposed method, CU partitioning information in reference pictures may be utilized for entropy encoding or decoding CU partitioning information for the current picture in a video coder. It is motivated by the fact that CU partitioning as illustrated in FIG. 12, is expected to be very similar among temporally adjacent frames. As illustrated in FIG. 12, when the partitioning results in a small CU, the neighbouring CUs are often small as well. On the other hand, when the partitioning results in a large CU, the neighbouring CUs are often large as well. In one embodiment, a video coder may entropy encode or decode the syntax information related to the CU split decision (e.g. split_cu_flag in VVC) for a current coding tree node by selecting one or more contexts depending on the CU partitioning information such as the CU width, height, and size around the corresponding region of the current coding node in a reference frame. In another embodiment, a video coder may entropy encode or decode the syntax information related to the CU split direction (e.g.

mtt_split_cu_vertical_flag in VVC) for a current coding tree node by selecting one or more contexts dependent on the CU partitioning information such as CU shape, width, height, and size around the corresponding region of the current coding node in a reference picture. The corresponding region of the current coding node in a reference picture can be a temporally co-located region with or without motion compensation.

This method is a content-dependent method. Therefore, it is proposed to turn on/off for this method for different picture/slice/tile/CTU-row/CTU/VPDU. The control flag for on/off is provided per picture/slice/tile/CTU-row/CTU/VPDU.

### Proposed Method B: Bilateral Matching Based Split Prediction

In this proposed method, information on the MV field derived on decoder side using bilateral matching as specified in [VVC or JVET-Y2025 (M. Coban, F. Le Léannec, J. Ström, “Algorithm description of Enhanced Compression Model 4 (ECM 4),” Joint Video Expert Team (JVET) of ITU-T SG 16 WP 3 and ISO/IEC JTC 1/SC 29, Doc. JVET-Y2025, 25rd Meeting, by teleconference, 12-21 Jan. 2022) may be utilized for entropy encoding or decoding the CU partitioning information for the current picture in a video coder. In one embodiment, a video coder can derive the MV field using bilateral matching, determine the MV diversity inside the region of a current coding tree node or the region of the parent coding tree node of a current coding tree node, and decide the context probability. In another embodiment, a video coder can derive the MV field using bilateral matching, estimate whether a current coding tree node belongs to a background region or a foreground object and give different context probabilities. This operation can be executed on a number of starting CTUs since it is beneficial for the initial context value. In an alternative embodiment, a video coder can derive the MV field using bilateral matching, estimate whether a current coding tree node belongs to a background region or a foreground object and predict the CU split decision. This operation can be executed on a number of starting CTUs since it is beneficial for initial context value.

This method is a content-dependent method. Therefore, it is proposed to turn on/off for this method for different picture/slice/tile/CTU-row/CTU/VPDU. The control flag for on/off is provided per picture/slice/tile/CTU-row/CTU/VPDU.

Proposed Method C: Different Probability Models between HBT and VBT of Non-Square Coding Tree Nodes

In this proposed method, different probability models may be allocated for entropy coding syntax information for indicating whether the split direction for a current non-square coding tree node is horizontal or vertical (e.g. mtt_split_cu_vertical_flag in VVC). For example, in an 8×128 CU, there may be a higher probability to partition it into 8×64 CUs instead of 4×128 CUs. A video coder may set HBT probability higher than VBT for context modelling. On the other hand, for a 128×8 CU, there may be higher probability to partition it into 64×8 CUs instead of 128×4 CUs. Alternatively, the video coder may assign one or more separate contexts for non-square coding tree nodes. In a video encoding system according to embodiments of the present invention, the encoder will use entropy encoding to the partition information (e.g. mtt_split_cu_vertical_flag in VVC) to generate one or more coded bits for the partition information. During the entropy coding process, the encoder may use probabilities for the HBT and VBT for context modelling. The coded bits will be signalled in the bitstream so that the decoder can use it to recover the partition information. At the decoder side, the coded bits for the partition information (e.g. mtt_split_cu_vertical_flag in VVC) will be parsed from the bitstream and decoded using entropy decoding. The partitioning information is then used for partitioning the current picture area (e.g. a CTU).

Context selection for entropy coding the split decision of a current non-square coding tree node may be dependent on the block shape of the current non-square coding tree node. Context selection may be further dependent on the split information on the associated parent node such as the split direction, size and/or shape of the parent node.

### Proposed Method D: Split Context Initialization

In VVC, a fixed set of parameters are utilized for deriving the initial context model probability values for entropy coding. In the present proposed method, the initial context model probability values for CU split flags and other syntax information related to CU split decisions may be derived adaptively according to the video contents. In a video encoder according to embodiments of the present invention, some partitioning information is entropy coded using one or more context models to generate one or more coded bits. The coded bits are then signalled in the bitstream. For the entropy encoding according to the present invention, the initial context model probability values for CU split flags and other syntax information related to CU split decisions may be derived adaptively according to the video contents. Similarly, during entropy decoding using context models, the initial context model probability values for CU split flags and other syntax information on CU split decisions may be derived adaptively according to the video contents. In one example, a video coder may assign different initial context model probability values for screen video contents. In another example, the video coder may assign initial context model probability values considering activity levels of input video contents. The syntax information for deriving initial context models adaptively can be signalled in one or more high-level syntax sets such as sequence parameter set (SPS), picture parameter set (PPS), picture head (PH), and slice header (SH).

This method is a content-dependent method. Therefore, it is proposed to turn on/off for this method for different picture/slice/tile/CTU-row/CTU/VPDU. The control flag for on/off is provided per picture/slice/tile/CTU-row/CTU/VPDU.

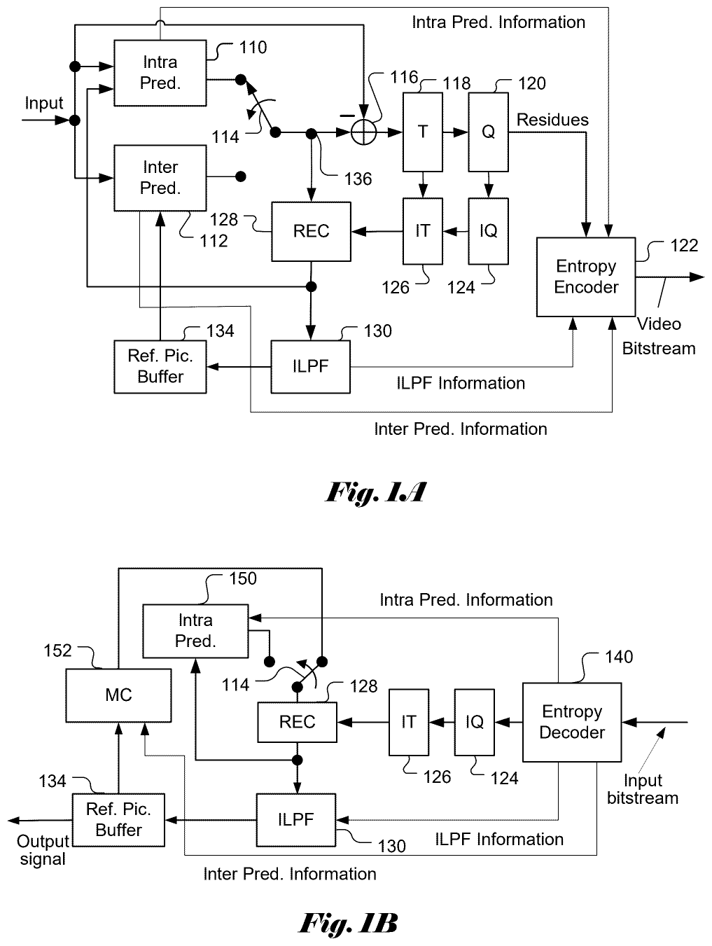

Any of the foregoing proposed methods for adaptive entropy coding of partitioning tree decision can be implemented in encoders and/or decoders. For example, any of the proposed methods can be implemented in an intra (e.g. Intra 150 in FIG. 1B), a motion compensation module (e.g. MC 152 in FIG. 1B), or an entropy coding module (e.g. Entropy Decoder 140 in FIG. 1B) of a decoder. Also, any of the proposed methods can be implemented in intra (e.g. Intra 110 in FIG. 1A), inter coding module of an encoder (e.g. Inter Pred. 112 in FIG. 1B), or an entropy coding module (e.g. Entropy Encoder 122 in FIG. 1A) of the encoder. Alternatively, any of the proposed methods can be implemented as one or more circuits or processors coupled to the inter/intra/prediction/entropy coding modules of the encoder and/or the inter/intra/prediction/entropy coding modules of the decoder, so as to provide the information needed by the inter/intra/prediction module.

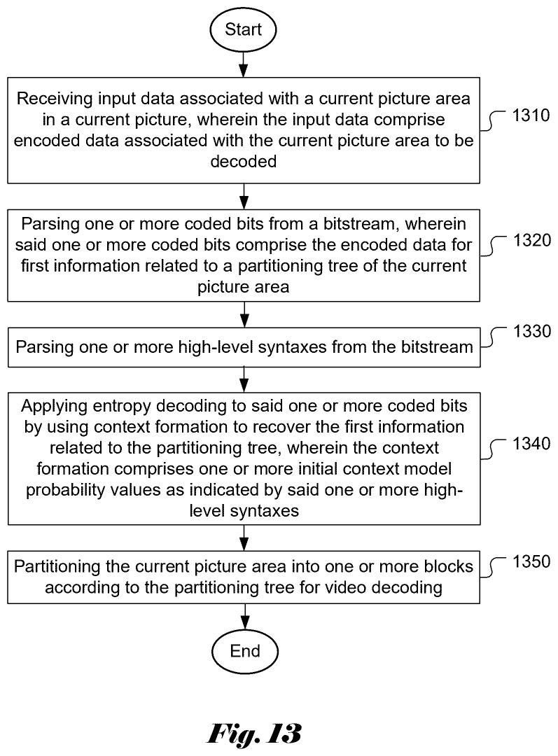

FIG. 13 illustrates a flowchart of an exemplary video decoding system that utilizes one or more initial context model probability values derived according to a video content type of the current picture for entropy decoding of the partition information according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current picture area in a current picture are received in step 1310, wherein the input data comprise encoded data associated with the current picture area to be decoded. One or more coded bits are parsed from a bitstream in step 1320, wherein said one or more coded bits comprise the encoded data for first information related to a partitioning tree of the current picture area. One or more high-level syntaxes are parsed from the bitstream in step 1330. Entropy decoding is applied to said one or more coded bits by using context formation to recover the first information related to the partitioning tree in step 1340, wherein the context formation comprises one or more initial context model probability values as indicated by said one or more high-level syntaxes. The current picture area is partitioned into one or more blocks according to the partitioning tree for decoding said one or more blocks in step 1350.

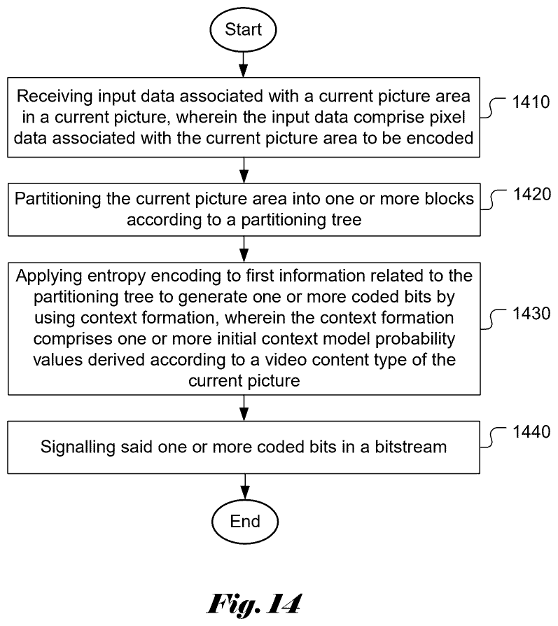

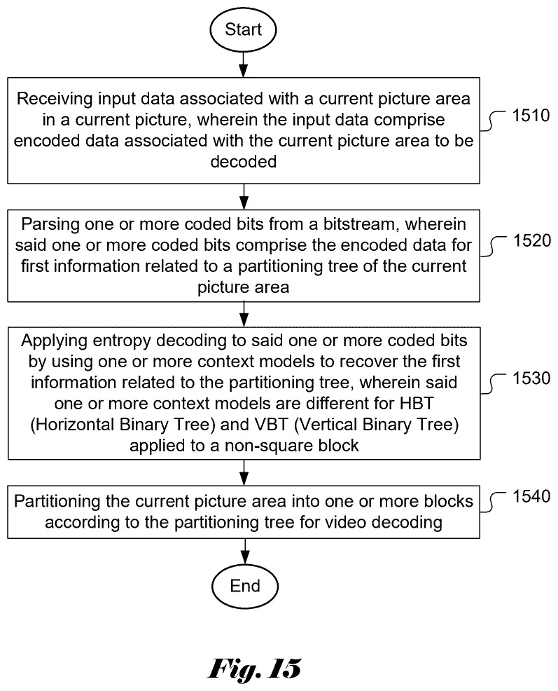

FIG. 14 illustrates a flowchart of an exemplary video decoding system that utilizes one or more initial context model probability values derived according to a video content type of the current picture for entropy decoding of the partition information according to an embodiment of the present invention. According to this method, input data associated with a current picture area in a current picture are received in step 1410, wherein the input data comprise pixel data associated with the current picture area to be encoded. The current picture area is partitioned into one or more blocks according to a partitioning tree in step 1420. Entropy encoding is applied to first information related to the partitioning tree to generate one or more coded bits by using context formation in step 1430, wherein the context formation comprises one or more initial context model probability values derived according to a video content type of the current picture. Said one or more coded bits in a bitstream are signalled in step 1440.

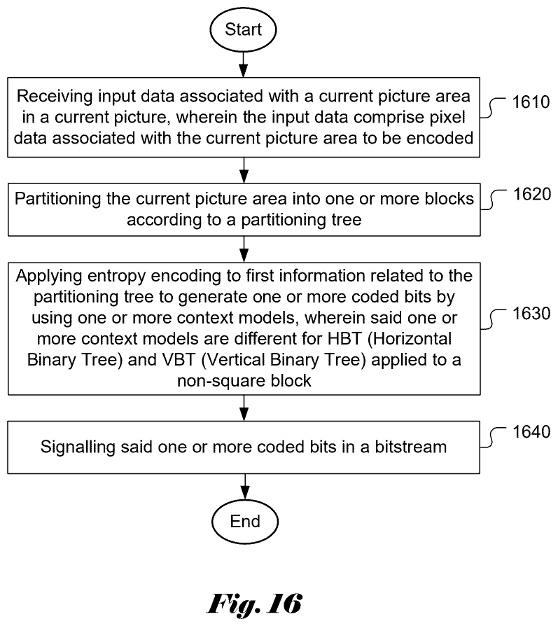

FIG. 15 illustrates a flowchart of an exemplary video decoding system that utilizes different context models for HBT and VBT for entropy decoding of the partition information according to an embodiment of the present invention. According to this method, input data associated with a current picture area in a current picture are received in step 1510, wherein the input data comprise encoded data associated with the current picture area to be decoded. One or more coded bits are parsed from a bitstream in step 1520, wherein said one or more coded bits comprise the encoded data for first information related to a partitioning tree of the current picture area. Entropy decoding is applied to said one or more coded bits by using one or more context models to recover the first information related to the partitioning tree in step 1530, wherein said one or more context models are different for HBT (Horizontal Binary Tree) and VBT (Vertical Binary Tree) applied to a non-square block. The current picture area is partitioned into one or more blocks according to the partitioning tree for decoding said one or more blocks in step 1540.

FIG. 16 illustrates a flowchart of an exemplary video encoding system that utilizes different context models for HBT and VBT for entropy encoding of the partition information according to an embodiment of the present invention. According to this method, input data associated with a current picture area in a current picture are received in step 1610, wherein the input data comprise pixel data associated with the current picture area to be encoded. The current picture area is partitioned into one or more blocks according to a partitioning tree in step 1620. Entropy encoding is applied to first information related to the partitioning tree to generate one or more coded bits by using one or more context models in step 1630, wherein said one or more context models are different for HBT (Horizontal Binary Tree) and VBT (Vertical Binary Tree) applied to a non-square block. Said one or more coded bits in a bitstream are signalled in step 1640.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video decoding, the method comprising:
receiving input data associated with a current picture area in a current picture, wherein the input data comprise encoded data associated with the current picture area to be decoded;
parsing one or more coded bits from a bitstream, wherein said one or more coded bits comprise the encoded data for first information related to a partitioning tree of the current picture area;
parsing one or more high-level syntaxes from the bitstream;
applying entropy decoding to said one or more coded bits by using context formation to recover the first information related to the partitioning tree, wherein the context formation comprises one or more initial context model probability values as indicated by said one or more high-level syntaxes; and
partitioning the current picture area into one or more blocks according to the partitioning tree for decoding said one or more blocks.

2. The method of claim 1, wherein the first information comprises one or more CU (Coding Unit) split flags.

3. The method of claim 2, wherein the first information comprises CU split decision other than said one or more CU split flags.

4. The method of claim 1, wherein said one or more initial context model probability values are derived according to a video content type.

5. The method of claim 4, wherein the video content type belongs to a group comprising screen video content, activity level of input video, or a combination thereof.

6. The method of claim 1, wherein said one or more high-level syntaxes are parsed from SPS (sequence parameter set), PPS (picture parameter set), PH (picture head), SH (slice header), or a combination thereof.

7. The method of claim 1, wherein whether to allow said one or more initial context model probability values is controlled by said one or more high-level syntaxes parsed from the bitstream.

8. The method of claim 1, wherein said one or more high-level syntaxes are parsed from the bitstream at a picture level, slice level, tile level, CTU-row level, CTU level, VPDU level, or a combination thereof.

9. A method of video encoding, the method comprising:
receiving input data associated with a current picture area in a current picture, wherein the input data comprise pixel data associated with the current picture area to be encoded;
partitioning the current picture area into one or more blocks according to a partitioning tree;
applying entropy encoding to first information related to the partitioning tree to generate one or more coded bits by using context formation, wherein the context formation comprises one or more initial context model probability values derived according to a video content type of the current picture; and
signalling said one or more coded bits in a bitstream.

10. The method of claim 9, wherein the first information comprises one or more CU (Coding Unit) split flags.

11. The method of claim 10, wherein the first information comprises CU split decision other than said one or more CU split flags.

12. The method of claim 9, wherein the video content type belongs to a group comprising screen video content, activity level of input video, or a combination thereof.

13. The method of claim 9, wherein one or more high-level syntaxes are signalled from the bitstream, wherein said one or more high-level syntaxes indicate said one or more initial context model probability values being selected from one of multiple initial context model sets.

14. The method of claim 13, wherein said one or more high-level syntaxes are signalled from SPS (sequence parameter set), PPS (picture parameter set), PH (picture head), SH (slice header), or a combination thereof.

15. The method of claim 9, wherein whether to allow said one or more initial context model probability values derived according to the video content type of the current picture is controlled by one or more high-level syntaxes parsed from the bitstream.

16. The method of claim 15, wherein said one or more high-level syntaxes are parsed from the bitstream at a picture level, slice level, tile level, CTU-row level, CTU level, VPDU level, or a combination thereof.

17. A method of video decoding, the method comprising:
receiving input data associated with a current picture area in a current picture, wherein the input data comprise encoded data associated with the current picture area to be decoded;
parsing one or more coded bits from a bitstream, wherein said one or more coded bits comprise the encoded data for first information related to a partitioning tree of the current picture area;
applying entropy decoding to said one or more coded bits by using one or more context models to recover the first information related to the partitioning tree, wherein said one or more context models are different for HBT (Horizontal Binary Tree) and VBT (Vertical Binary Tree) applied to a non-square block; and
partitioning the current picture area into one or more blocks according to the partitioning tree for video decoding.

18. The method of claim 17, wherein for the non-square block with block height larger than block width, the non-square block has a higher probability to be partitioned using the HBT than the VBT, and wherein for the non-square block with the block width larger than the block height, the non-square block has the higher probability to be partitioned using the VBT than the HBT.

19. The method of claim 17, wherein said one or more context models are further dependent on block shape of the non-square block.

20. The method of claim 17, wherein said one or more context models are further dependent on split information, block size, block shape, or a combination thereof related to a parent node of the non-square block.

21. A method of video encoding, the method comprising:
receiving input data associated with a current picture area in a current picture, wherein the input data comprise pixel data associated with the current picture area to be encoded;
partitioning the current picture area into one or more blocks according to a partitioning tree;
applying entropy encoding to first information related to the partitioning tree to generate one or more coded bits by using one or more context models, wherein said one or more context models are different for HBT (Horizontal Binary Tree) and VBT (Vertical Binary Tree) applied to a non-square block; and
signalling said one or more coded bits in a bitstream.

22. The method of claim 21, wherein for the non-square block with block height larger than block width, the non-square block has a higher probability to be partitioned using the HBT than the VBT, and wherein for the non-square block with the block width larger than the block height, the non-square block has the higher probability to be partitioned using the VBT than the HBT.

23. The method of claim 21, wherein said one or more context models are further dependent on block shape of the non-square block.

24. The method of claim 21, wherein said one or more context models are further dependent on split information, block size, block shape, or a combination thereof related to a parent node of the non-square block.
